(19) United States
(12) Patent Application Publication
(10) Pub. No.: US 2001/0050638 A1
(43) Pub. Date: Dec. 13, 2001

(54) Microstrip antenna

(75) Inventors: Norimasa Ishitobi, Tokyo (JP); Hideaki Shimoda, Tokyo (JP)

Correspondence Address: ARMSTRONG,WESTERMAN, HATTORI,, MCLELAND & NAUGHTON, LLP, 1725 K STREET, NW, SUITE 1000, WASHINGTON, DC, 20006, US

(73) Assignee: TDK CORPORATION, Tokyo (JP)

(21) Appl. No.: 09/836,181

(22) Filed: Apr. 18, 2001

Related U.S. Application Data
(63) Continuation of application No. PCT/JP00/05192, filed on Aug. 3, 2000.

(30) Foreign Application Priority Data
Aug. 20, 1999 (JP) 233949/1999

(51) Int. Cl. H01Q 1/48

(52) U.S. Cl. 343/700 MS; 343/846

(57) ABSTRACT

A microstrip antenna includes a ground electrode and a patch electrode supported to face with each other via a dielectric layer. The patch electrode has a reactance-mounted pattern which includes one end section, the other end section and a center section between the end sections. The end sections are located along a current flow direction and have a large width. The center section has a width smaller than that of the end sections. Each of contours of inside corners of the reactance-mounted pattern is formed by a continuous smooth curve.

### CROSS-REFERENCES TO RELATED APPLICATIONS

This is a continuation of International Application PCT/JP00/05192, with an international filing date of Aug. 3, 2000.

### FIELD OF THE INVENTION

The present invention relates to a microstrip antenna used as an internal antenna mounted in a portable telephone or in a mobile terminal for example.

### DESCRIPTION OF THE RELATED ART

A typical microstrip antenna mounted in a portable telephone or in a mobile terminal such as a GPS (Global Positioning System) terminal is a λ/2 patch antenna, where λ represents a wavelength in operating frequency.

The λ/2 patch antenna basically consists of a dielectric substrate that has a rectangular or circular conductor pattern or patch pattern with a side length or a diameter of about k on one surface, and a ground conductor on the other surface.

A bandwidth BW of the patch antenna is given from an equation of;

BW=(1/Q_{c})+(1/Q_{d})+(1/Qᵣ)=1/Q₀,

and an efficiency TI thereof is given from an equation of;

η=Q₀/Qᵣ=1/(BWQᵣ),

where Q_{c} is a quality factor due to the conductor loss, Q_{d} is a quality factor due to the dielectric loss, Qᵣ is a quality factor due to the radiation loss, and Q₀ is a quality factor due to the total loss of the antenna.

As will be apparent from the above equations, it is necessary to reduce the quality factor Q₀ in order to increase the bandwidth of the antenna, and also it is necessary to make the quality factor Qᵣ to be smaller than the quality factors Q_{c} and Q_{d} in order to increase the efficiency η of the antenna.

FIG. 1 is a graph illustrating typical characteristics of these quality factors with respect to parameters representing the size of the antenna. In the graph, the vertical axis represents a quality factor Q, and the horizontal axis represents, in a log scale, parameters of the antenna size such as a side length b of the rectangular patch pattern, a diameter D of the circular patch pattern, a thickness h of the substrate and an wavelength reduction rate 1/\sqrt{ε}ᵣ due to the dielectric of the substrate.

As will be noted from the figure, in such patch antenna, the quality factor Q_{d} due to the dielectric loss is extremely larger than the quality factors Q_{d}, Qᵣ and Q₀ due to other losses. Therefore, the quality factor Q_{d} will not contribute to improve the efficiency of the antenna. The quality factor Q due to the conductor loss increases depending upon the increase of the antenna in size, whereas the quality factor Qᵣ due to the radiation loss decreases depending upon the increase in the antenna size.

At a point where Qᵣ=Q_{c} in the center section of FIG. 1, if Q_{d}>>Qᵣ,Q_{c}, the efficiency of the antenna η will become η=50%. If the size of the antenna is reduced from this point, in other words, if the graph of FIG. 1 is progressed leftward along the horizontal axis, the quality factor Q₀ of the whole antenna approaches the factor Q_{c}, namely, BW≅1/Q_{c} and η≅Q_{c}/Q_{r.}

This means that, when the antenna size is reduced, the bandwidth BW and the efficiency η of the antenna are determined in accordance with the quality factor Q_{c} due to the conductor loss.

However, as will be understood from FIG. 1, increasing of the factor Q_{c} due to the conductor loss and downsizing of the antenna are mutually contradictory.

### SUMMARY OF THE INVENTION

It is therefore an object of the present invention to provide a microstrip antenna, whereby a bandwidth BW and an efficiency η of the antenna can be improved with downsizing the antenna.

According to the present invention, a microstrip antenna includes a ground electrode and a patch electrode supported to face with each other via a dielectric layer. The patch electrode has a reactance-mounted pattern which includes one end section, the other end section and a center section between the end sections. The end sections are located along a current flow direction and have a large width. The center section has a width smaller than that of the end sections. Each of contours of inside corners of the reactance-mounted pattern is formed by a continuous smooth curve.

A patch pattern is configured by the end sections located along a current flow direction, with a large width, and the center section with a width smaller than that of the end sections. By widening the end sections, magnetic field concentration decreases to lower the inductance at these sections and the area increases to up the capacitance at these sections. Contrary to this, by narrowing the center section, the magnetic field concentrates to up the inductance at this section and the area decreases to lower the capacitance at this section. Thus, the resonant frequency is reduced by making the both end sections charged at a high potential into more capacitive and also by making the center section charged at a low potential into more inductive. As a result, the microstrip antenna can be more downsized.

If the pattern is downsized, resistance at the inside corners between the narrow center section and the wide end sections will increase due to current concentration. However, according to the present invention, since each of edges or contours of inside corners of the patch pattern is formed by a continuous smooth curve, the conductor loss can be reduced without upsizing the pattern causing the quality factor Q_{c} to rise. Accordingly, both improvement of the efficiency η and the bandwidth BW and downsizing of the antenna can be expected.

If an air layer is used as the dielectric layer, since no dielectric material is needed, the manufacturing cost can be greatly reduced.

In case that a dielectric material substrate is used as the dielectric layer, the ground electrode is formed on a bottom surface of the dielectric substrate and the patch electrode is formed on a top surface of the dielectric substrate. In the latter case, since the dielectric substrate can be formed using a low-cost general dielectric material without using an expensive dielectric material, the manufacturing cost of the microstrip antenna can be kept low.

It is preferred that the reactance-mounted pattern has a geometry being symmetric with respect to an axis along the current flow direction.

In this case, each of the end sections of the reactance-mounted pattern may have a rectangular shape, a circular or ellipse shape.

It is also preferred that the reactance-mounted pattern has a geometry being symmetric with respect to a center point of the patch electrode.

In this case, the reactance-mounted pattern may have a geometry similar to a S-character shape, a geometry similar to two S-character shapes crossed each other, or a geometry similar to an orthogonal cross shape.

It is further preferred that each of contours of outside corners of the reactance-mounted pattern is formed by a continuous smooth curve.

Further objects and advantages of the present invention will be apparent from the following description of the preferred embodiments of the invention as illustrated in the accompanying drawings.

### BRIEF DESCRIPTION OF THE DRAWINGS

FIG. 1 shows a graph illustrating typical characteristics of the quality factors of the antenna with respect to the parameters representing the size of the antenna;

FIG. 2 shows an oblique view schematically illustrating a microstrip antenna in a preferred embodiment according to the present invention;

FIG. 3 shows a plane view illustrating a patch pattern shown in FIG. 2;

FIG. 4 shows a plane view illustrating a patch pattern of a microstrip antenna in another embodiment according to the present invention;

FIG. 5 shows a plane view illustrating a patch pattern of a microstrip antenna in a further embodiment according to the present invention;

FIG. 6 shows a plane view illustrating a patch pattern of a microstrip antenna in a still further embodiment according to the present invention;

FIG. 7 shows a plane view illustrating a patch pattern of a microstrip antenna in a more still further embodiment according to the present invention;

FIG. 8 shows a plane view illustrating a patch pattern of a microstrip antenna in a further embodiment according to the present invention; and

FIG. 9 shows a plane view illustrating a patch pattern of a microstrip antenna in a still further embodiment according to the present invention.

### DESCRIPTION OF THE PREFERRED EMBODIMENTS

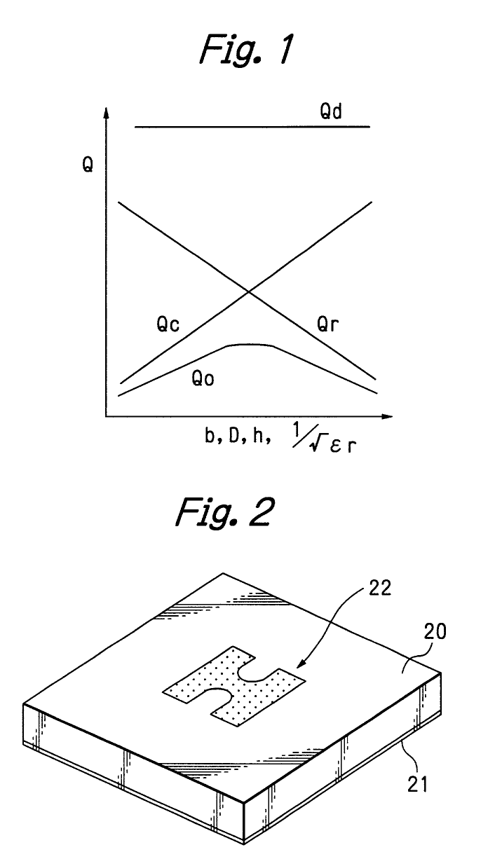

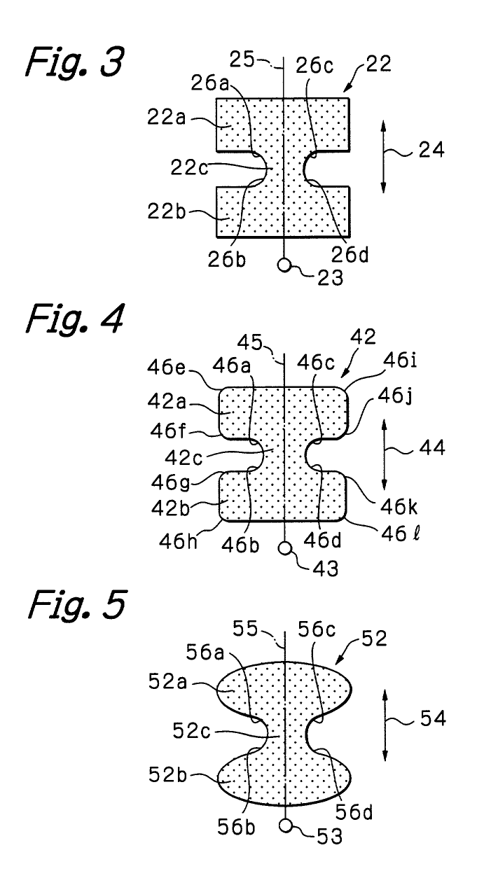

FIG. 2 schematically illustrates a microstrip antenna in a preferred embodiment according to the present invention, and FIG. 3 illustrates a patch pattern shown in FIG. 2.

In these figures, reference numeral 20 denotes a dielectric substrate, 21 a ground electrode formed over the whole area of a bottom surface of the substrate 20, 22 a patch electrode formed on a top surface of the substrate 20, and 23 a power feeding terminal, respectively.

The dielectric substrate 20 is made of a general dielectric material such as a ceramic dielectric material for high frequency application with a relative dielectric constant of about εᵣ=38 for example.

The ground electrode 21 and the patch electrode 22 are formed by patterning conductive layers of metallic material such as copper or silver, deposited on the bottom and top surfaces of the substrate 20, respectively. More specifically, these electrodes are formed by pattern-printing a metallic paste of silver for example on the substrate and baking the printed paste, by plating a metallic patterned layer on the substrate, or by etching a thin metal film on the substrate.

The power feeding terminal 23 is electrically connected with the patch electrode 22 at an arbitrary position on an axis 25 that is in parallel with the direction 24 of current flow except for the center point of the patch electrode 22.

In this embodiment, the patch pattern of the patch electrode 22 is symmetric with respect to the axis 25 running along the current flow direction 24. One end section 22a and the other end section 22b of the patch electrode 22, located along the current flow direction 24, are formed in a rectangular shape with a large width or a large length in a direction perpendicular to the current flow direction 24. A center section 22c of the patch electrode 22 is formed in a shape with a width smaller than that of the end sections 22a and 22b. Particularly, in this embodiment, each of edges or contours 26a-26d of inside corners between this center section 22c and the end sections 22a and 22b is formed by a continuous smooth curve. In other words, the inside corner contours 26a-26d are rounded.

The width of the end sections 22a and 22b is determined to a value shorter than λ/2. It is desirable to determine the width of the center section 22c as small as possible within an allowable range for fabrication so as to downsize the antenna. As for an unrestricted example of the embodiment, a length along the axis 25 of each of the end sections 22a and 22b is determined to about λ/8, and a length along the axis 25 of the center section 22c is determined to about λ/4.

The end sections 22a and 22b may be formed in any shape other than the rectangular shape, for example, in a triangular shape, a polygonal shape or a trapezoidal shape.

By widening the end sections 22a and 22b, magnetic field concentration decreases to lower the inductance at these sections and the area increases to up the capacitance at these sections. Contrary to this, by narrowing the center section 22c, the magnetic field concentrates to up the inductance at this section and the area decreases to lower the capacitance at this section. Thus, the resonant frequency is reduced so as to further downsize the microstrip antenna by making the both end sections 22a and 22b charged at a high potential into more capacitive and also by making the center section 22c charged at a low potential into more inductive. The dielectric substrate 20 can be formed using a low-cost general dielectric material without using an expensive dielectric material. Thus, the manufacturing cost of the microstrip antenna will be kept low.

Particularly, according to this embodiment, each of edges or contours 26a-26d of inside corners of the patch pattern is formed by a continuous smooth curve. Thus, it is possible to suppress the increasing of resistance due to current concentration at these inside corners. As a result, the conductor loss can be reduced without upsizing the pattern causing the quality factor Q_{c} to rise. Accordingly, both improvement of the efficiency η and the bandwidth BW and downsizing of the antenna can be expected.

FIG. 4 illustrates a patch pattern of a microstrip antenna in another embodiment according to the present invention.

As shown in the figure, the patch pattern of a patch electrode 42 is symmetric with respect to a axis 45 that is in parallel with the direction 44 of current flow. One end section 42a and the other end section 42b of the patch electrode 42, located along the current flow direction 44, are formed in a rectangular shape with a large width or a large length in a direction perpendicular to the current flow direction 44. A center section 42c of the patch electrode 42 is formed in a shape with a width smaller than that of the end sections 42a and 42b. Particularly, in this embodiment, not only each of edges or contours 46a-46d of inside corners between this center section 42c and the end sections 42a and 42b but also each of edges or contours 46e-46l of outside corners of the end sections 42a and 42b are formed by a continuous smooth curve. In other words, the inside corner contours 46a-46d and the outside corner contours 46e-46l are rounded.

A power feeding terminal 43 is electrically connected with the patch electrode 42 at an arbitrary position on the axis 45 running along a current flow direction 44 except for the center point of the patch electrode 42.

The end sections 42a and 42b may be formed in any shape other than the rectangular shape, for example, in a triangular shape, a polygonal shape or a trapezoidal shape.

Another configurations, modifications, operations and advantages in this embodiment are the same as those of the embodiment shown in FIGS. 1 and 2.

FIG. 5 illustrates a patch pattern of a microstrip antenna in a further embodiment according to the present invention.

As shown in the figure, the patch pattern of a patch electrode 52 is symmetric with respect to a axis 55 that is in parallel with the direction 54 of current flow. One end section 52a and the other end section 52b of the patch electrode 52, located along the current flow direction 54, are formed in an ellipse shape with a large width or a large length in a direction perpendicular to the current flow direction 54. A center section 52c of the patch electrode 52 is formed in a shape with a width smaller than that of the end sections 52a and 52b. Particularly, in this embodiment, each of edges or contours 56a-56d of inside corners between this center section 52c and the end sections 52a and 52b is formed by a continuous smooth curve. In other words, the inside corner contours 56a-56d are rounded.

A power feeding terminal 53 is electrically connected with the patch electrode 52 at an arbitrary position on the axis 55 running along a current flow direction 54 except for the center point of the patch electrode 52.

The end sections 52a and 52b may be formed in any rounded shape other than the ellipse shape, for example, in a circular shape.

Another configurations, modifications, operations and advantages in this embodiment are the same as those of the embodiment shown in FIGS. 1 and 2.

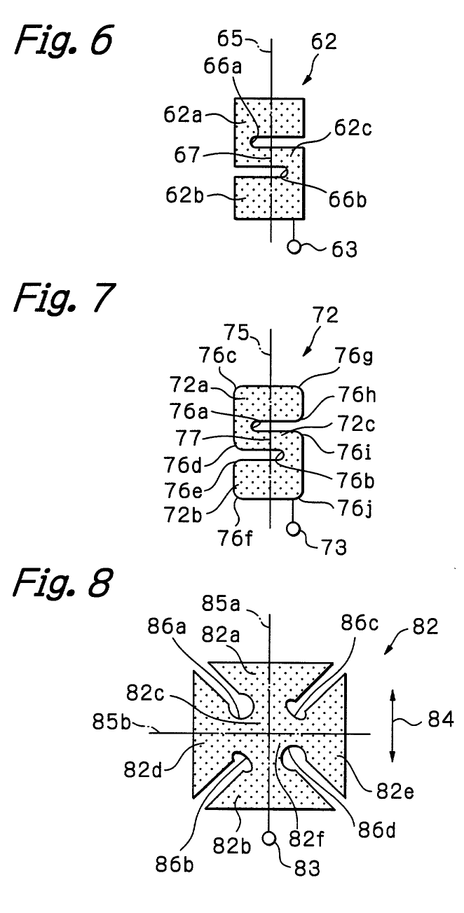

FIG. 6 illustrates a patch pattern of a microstrip antenna in a still further embodiment according to the present invention.

As shown in the figure, the patch pattern of a patch electrode 62 is asymmetric with respect to a center line 65 of the antenna but symmetric with respect to a center point 67 of the antenna, and has a S-character shape. One end section 62a and the other end section 62b of the patch electrode 62, located along the direction of current flow, are formed in a rectangular shape with a large width or a large length in a direction perpendicular to the current flow direction. A center section 62c of the patch electrode 62 is formed in a strip shape with a width smaller than that of the end sections 62a and 62b. Particularly, in this embodiment, each of edges or contours 66a and 66b of inside corners between this center section 62c and the end sections 62a and 62b is formed by a continuous smooth curve. In other words, the inside corner contours 66a and 66b are rounded.

A power feeding terminal 63 is electrically connected with the patch electrode 62.

The end sections 62a and 62b may be formed in any shape other than the rectangular shape, for example, in a triangular shape, a polygonal shape or a trapezoidal shape.

In case of a λ/2 antenna, if its electrode pattern has an asymmetric shape, an orthogonal resonance mode is excited and thus produced cross polarization components may be outputted. However, for a small sized antenna such as the microstrip antenna according to the present invention, the cross polarization characteristics is not important. Rather, by forming the S-character shaped patch pattern that is symmetric with respect to the center point as in this embodiment, the center section 62c having the small width can be increased in length with keeping its area at constant, and also the area of the end sections 62a and 62b can be increased. Thus, the resonant frequency is reduced so as to further downsize the microstrip antenna by increasing the inductance of the center section 62c charged at a low potential and by increasing the capacitance of the both end sections 62a and 62b charged at a high potential.

Particularly, according to this embodiment, each of edges or contours 66a and 66b of inside corners of the patch pattern is formed by a continuous smooth curve. Thus, it is possible to suppress the increasing of resistance due to current concentration at these inside corners. As a result, the conductor loss can be reduced without upsizing the pattern causing the quality factor Q_{c} to rise. Accordingly, both improvement of the efficiency η and the bandwidth BW and downsizing of the antenna can be expected.

Another configurations, modifications, operations and advantages in this embodiment are the same as those of the embodiment shown in FIGS. 1 and 2.

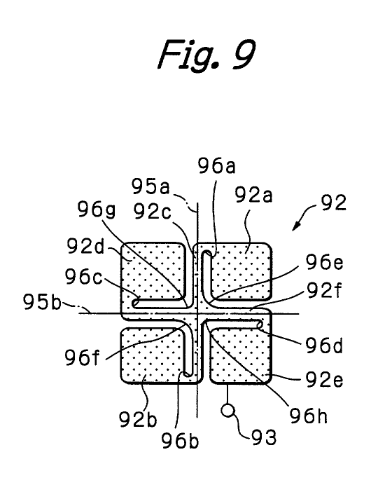

FIG. 7 illustrates a patch pattern of a microstrip antenna in a more still further embodiment according to the present invention.

As shown in the figure, the patch pattern of a patch electrode 72 is asymmetric with respect to a center line 75 of the antenna but symmetric with respect to a center point 77 of the antenna, and has a S-character shape. One end section 72a and the other end section 72b of the patch electrode 72, located along the direction of current flow, are formed in a rectangular shape with a large width or a large length in a direction perpendicular to the current flow direction. A center section 72c of the patch electrode 72 is formed in a strip shape with a width smaller than that of the end sections 72a and 72b. Particularly, in this embodiment, not only each of edges or contours 76a and 76b of inside corners between this center section 72c and the end sections 72a and 72b but also each of edges or contours 76c-76j of outside corners of the end sections 72a and 72b are formed by a continuous smooth curve. In other words, the inside corner contours 76a and 76b and the outside corner contours 76c-76j are rounded.

A power feeding terminal 73 is electrically connected with the patch electrode 72.

The end sections 72a and 72b may be formed in any shape other than the rectangular shape, for example, in a triangular shape, a polygonal shape or a trapezoidal shape.

In case of a λ/2 antenna, if its electrode pattern has an asymmetric shape, an orthogonal resonance mode is excited and thus produced cross polarization components may be outputted. However, for a small sized antenna such as the microstrip antenna according to the present invention, the cross polarization characteristics is not important. Rather, by forming the S-character shaped patch pattern that is symmetric with respect to the center point as in this embodiment, the center section 72c having the small width can be increased in length with keeping its area at constant, and also the area of the end sections 72a and 72b can be increased. Thus, the resonant frequency is reduced so as to further downsize the microstrip antenna by increasing the inductance of the center section 72c charged at a low potential and by increasing the capacitance of the both end sections 72a and 72b charged at a high potential.

Particularly, according to this embodiment, each of edges or contours 76a and 76b of inside corners and each of edges or contours 76c-76j of outside corner of the patch pattern are formed by continuous smooth curves. Thus, it is possible to suppress the increasing of resistance due to current concentration at these inside corners. As a result, the conductor loss can be reduced without upsizing the pattern causing the quality factor Q_{c} to rise. Accordingly, both improvement of the efficiency η and the bandwidth BW and downsizing of the antenna can be expected.

Another configurations, modifications, operations and advantages in this embodiment are the same as those of the embodiment shown in FIGS. 1 and 2.

FIG. 8 illustrates a patch pattern of a microstrip antenna in a further embodiment according to the present invention.

As shown in the figure, the patch pattern of a patch electrode 82 is formed in a cross shape with crossed patterns running along a first center line 85a that is in parallel with a direction 84 of first resonant mode current flow and running along a second center line 85b that is perpendicular to the current flow direction 84, respectively. One end section 82a and the other end section 82b of the patch electrode 82, located along the direction 84 of first resonant mode current flow, are formed in a trapezoidal shape with a large width. A center section 82c is formed in a shape with a width smaller than that of the end sections 82a and 82b. One end section 82d and the other end section 82e of the patch electrode 82, located along a direction of current flow of a second resonant mode that is perpendicular to the first resonant mode, are formed in a trapezoidal shape with a large width. A center section 82f is formed in a shape with a width smaller than that of the end sections 82d and 82e.

Particularly, in this embodiment, each of edges or contours 86a-86d of inside corners between the center section 82c and the end sections 82a and 82b and between the center section 82f and the end sections 82d and 82e is formed by a continuous smooth curve. In other words, the inside corner contours 86a-86d are rounded.

A power feeding terminal 83 is electrically connected with the patch electrode 62.

The patch pattern in this embodiment has a geometry with two patterns crossed with each other. Vertical and horizontal symmetrical form of this geometry are slightly broken so as to couple two orthogonal resonant modes at the same frequency with each other. More concretely, the contours 86a-86d of this patch pattern are formed so that the contours 86a and 86c become asymmetric with respect to the first center line 85a, that the contours 86b and 86d become asymmetric with respect to the first center line 85a, that the contours 86a and 86b become asymmetric with respect to the second center line 85b, and that the contours 86c and 86d become asymmetric with respect to the second center line 85b. Thus, the two orthogonal resonant modes are coupled resulting the frequency band to greatly widen. In addition, according to this embodiment, since each of edges or contours 86a-86d of inside corners of the patch pattern is formed by a continuous smooth curve, it is possible to suppress the increasing of resistance due to current concentration at these inside corners. As a result, the conductor loss can be reduced without upsizing the pattern causing the quality factor Q_{c} to rise. Accordingly, both improvement of the efficiency η and the bandwidth BW and downsizing of the antenna can be expected.

In this embodiment, the asymmetry in shape is attained by forming the contours 86a and 86d arranged in one diagonal direction to have a different radius of curvature from that of the contours 86b and 86c arranged in the other diagonal direction. However, in modifications, the asymmetry may be attained by forming the contours 86a and 86d in a shape with a slit or an incision different from that of the contours 86b and 86c. It is possible to provide the asymmetry by forming only one contour to have a different shape from that of the remaining contours.

The end sections 82a, 82b, 82d and 82e may be formed in any shape other than the trapezoidal shape, for example, in a triangular shape, a rectangular shape or a polygonal shape.

Another configurations, modifications, operations and advantages in this embodiment are the same as those of the embodiment shown in FIGS. 1 and 2.

FIG. 9 illustrates a patch pattern of a microstrip antenna in a still further embodiment according to the present invention.

As shown in the figure, the patch pattern of a patch electrode 92 is formed in a shape with two S-character crossed patterns running along a first center line 95a and running along a second center line 95b that is perpendicular to the first center line 95a, respectively. One end section 92a and the other end section 92b of the patch electrode 92, located along the first center line 95a, are formed in a rectangular shape with a large width or a large length in a direction perpendicular to the current flow direction. A center section 92c for connecting these end sections 92a and 92b is formed in a strip shape with a width smaller than that of the end sections 92a and 92b. One end section 92d and the other end section 92e of the patch electrode 92, located along the second center line 95b, are formed in a rectangular shape with a large width. A center section 92f for connecting these end sections 92d and 92e is formed in a strip shape with a width smaller than that of the end sections 92d and 92e.

Particularly, in this embodiment, each of edges or contours 96a-96d of inside corners between the strip section 92c and the end sections 92a and 92b and between the strip section 92f and the end sections 92d and 92e, and also each of edges or contours 96e-96h of inside corners at the crossing portion of the strip sections 92c and 92f are formed by a continuous smooth curve. In other words, the inside corner contours 96a-96h are rounded.

A power feeding terminal 93 is electrically connected with the patch electrode 92.

The patch pattern in this embodiment also has a geometry with two patterns crossed with each other. Vertical and horizontal symmetrical form of this geometry are slightly broken so as to couple two orthogonal resonant modes at the same frequency with each other. More concretely, the contours 96e-96f of the patch pattern are formed so that the contours 96e and 96g become asymmetric with respect to the first center line 95a, that the contours 96f and 96h become asymmetric with respect to the first center line 95a, that the contours 96e and 96h become asymmetric with respect to the second center line 95b, and that the contours 96f and 96g become asymmetric with respect to the second center line 95b. Thus, the two orthogonal resonant modes are coupled resulting the frequency band to greatly widen. In addition, according to this embodiment, since each of edges or contours 96a-96h of inside corners of the patch pattern is formed by a continuous smooth curve, it is possible to suppress the increasing of resistance due to current concentration at these inside corners. As a result, the conductor loss can be reduced without upsizing the pattern causing the quality factor Q_{c} to rise. Accordingly, both improvement of the efficiency η and the bandwidth BW and downsizing of the antenna can be expected.

In this embodiment, the asymmetry in shape is attained by forming the contours 96e and 96f arranged in one diagonal direction to have a different radius of curvature from that of the contours 96g and 96h arranged in the other diagonal direction. However, in modifications, the asymmetry may be attained by forming the contours 96e and 96f in a shape with a slit or an incision different from that of the contours 96g and 96h. It is possible to provide the asymmetry by forming only one contour to have a different shape from that of the remaining contours.

The end sections 92a, 92b, 92d and 92e may be formed in any shape other than the rectangular shape, for example, in a triangular shape, a trapezoidal shape, a polygonal shape, a circular shape or an ellipse shape.

Another configurations, modifications, operations and advantages in this embodiment are the same as those of the embodiment shown in FIGS. 1 and 2.

In the aforementioned embodiments, the microstrip antenna has the ground electrode on the bottom surface of the dielectric substrate and the patch electrode on the top surface of the substrate. However, the present invention is applicable to a microstrip antenna with no dielectric substrate but with a ground electrode and a patch electrode supported by an appropriate supporting means to face with each other via air. In the latter case, since no dielectric material is needed by using an air layer as a dielectric layer, the manufacturing cost can be greatly reduced.

As mentioned in detail, according to the present invention, a patch pattern is configured by one end section and the other end section located along a current flow direction, with a large width and a center section with a width smaller than that of the end sections. By widening the end sections, magnetic field concentration decreases to lower the inductance at these sections and the area increases to up the capacitance at these sections. Contrary to this, by narrowing the center section, the magnetic field concentrates to up the inductance at this section and the area decreases to lower the capacitance at this section. Thus, the resonant frequency is reduced by making the both end sections charged at a high potential into more capacitive and also by making the center section charged at a low potential into more inductive. As a result, the microstrip antenna can be more downsized.

If the pattern is downsized, resistance at the inside corners between the narrow center section and the wide end sections will increase due to current concentration. However, according to the present invention, since each of edges or contours of inside corners of the patch pattern is formed by a continuous smooth curve, the conductor loss can be reduced without upsizing the pattern causing the quality factor Q_{c} to rise. Accordingly, both improvement of the efficiency η and the bandwidth BW and downsizing of the antenna can be expected.

Many widely different embodiments of the present invention may be constructed without departing from the spirit and scope of the present invention. It should be understood that the present invention is not limited to the specific embodiments described in the specification, except as defined in the appended claims.

What is claimed is:

1. A microstrip antenna comprising a ground electrode and a patch electrode supported to face with each other via a dielectric layer, said patch electrode having a reactance-mounted pattern which includes one end section, the other end section and a center section between the end sections, said end sections being located along a current flow direction and having a large width, said center section having a width smaller than that of said end sections, each of contours of inside corners of said reactance-mounted pattern being formed by a continuous smooth curve.

2. The micros trip antenna as claimed in claim 1, wherein said dielectric layer is an air layer.

3. The microstrip antenna as claimed in claim 1, wherein said dielectric layer is a dielectric material substrate, and wherein said ground electrode is formed on a bottom surface of said dielectric substrate and said patch electrode is formed on a top surface of said dielectric substrate.

4. The microstrip antenna as claimed in claim 1, wherein said reactance-mounted pattern has a geometry being symmetric with respect to an axis along the current flow direction.

5. The microstrip antenna as claimed in claim 4, wherein each of said end sections of said reactance-mounted pattern has a rectangular shape.

6. The microstrip antenna as claimed in claim 4, wherein each of said end sections of said reactance-mounted pattern has a circular or ellipse shape.

7. The microstrip antenna as claimed in claim 1, wherein said reactance-mounted pattern has a geometry being symmetric with respect to a center point of said patch electrode.

8. The microstrip antenna as claimed in claim 7, wherein said reactance-mounted pattern has a geometry similar to a S-character shape.

9. The micros trip antenna as claimed in claim 7, wherein said reactance-mounted pattern has a geometry similar to two S-character shapes crossed each other.

10. The microstrip antenna as claimed in claim 7, wherein said reactance-mounted pattern has a geometry similar to an orthogonal cross shape.

11. The microstrip antenna as claimed in claim 1, wherein each of contours of outside corners of said reactance-mounted pattern is formed by a continuous smooth curve.
